(19) United States
(12) Patent Application Publication
(10) Pub. No.: US 2011/0153558 A1
(43) Pub. Date: Jun. 23, 2011

(54) CONFIGURATION ITEM RECONCILIATION

(76) Inventors: Olga TUBMAN, Rishon (IL); Nimrod Nahum, Tel Aviv (IL)

(21) Appl. No.: 12/646,069

(22) Filed: Dec. 23, 2009

(51) Int. Cl. G06F 17/30

(52) U.S. Cl. 707/609; 707/758; 707/E17.014; 707/E17.005

(57) ABSTRACT

Systems, methods and computer-readable storage media or provided for reconciling an input configuration item (“CI”) with one or more existing CIs, each CI representing an entity on a computer network. An existing CI may be identified as a potential equivalent to the input CI where a first attribute of the existing CI has a value that matches a value of a first attribute of the input CI. The existing CI may be eliminated as a potential equivalent, however, where a comparison of a value of a second attribute of the existing CI with a value of a second attribute of the input CI indicates a mismatch.

### BACKGROUND

A computer system may have various attributes, based on hardware and software components of the computer system. For example, a computer system may have an operating system attribute of UNIX, an IP address attribute of 164.2.3.4, and a MAC address attribute of 35938a48-a6f5-4865-b996-b68c2ffd01bb. Some attributes may be suitable for identifying an instance of a computer system in the short term, for instance, as a configuration item (“CI”) in a configuration management database system (“CMDB”).

Over the long term, however, computer systems may change. Components of a computer system may be upgraded, replaced with different components, removed, added or otherwise altered, until the computer system has few or no original components left. As components are replaced or upgraded, attributes of the computer system change. This may referred to as “system drift.”

The table depicted in FIG. 1 shows components of an example computer system at three different times, demonstrating system drift. As shown in FIG. 1, a computer system may lack an attribute that is suitable to serve as an identifier in a CMDB at all.

In addition to attributes changing, a computer system may lack a single attribute that is suitable for unique identification of the computer system over any length of time. For example, MAC addresses once were hard-coded and unique, and thus, were usable to uniquely identify a computer system on a network. However, duplicate MAC addresses now may be used on a single network interface, which makes a MAC address unsuitable for unique identification of a computer system.

Depending on mechanisms available for discovering computer systems on a network, security of the computer systems and/or network, and the attributes of computer systems that are available for discovery, a discovery application may only have access to a limited set of attributes with which to identify a computer system. For example, a particular computer system may be configured to respond to ping requests, which may make particular information about that computer system available to a discovery application. However, the same information may not be available in other computer systems with ping requests disabled.

Moreover, some attributes that at first appear to be suitable for identification may be misinterpreted. For example, an IP-range discovery application may discover two IP addresses and create two separate CIs. However, these two IP addresses may be associated with two different network interfaces on a single host.

### BRIEF DESCRIPTION OF THE DRAWINGS

FIG. 1 depicts a table that demonstrates system drift.

FIGS. 2A-B depict a method of reconciling an input CI with existing CIs and merging equivalent existing CIs, according to an embodiment of the invention.

FIG. 3 depicts an example scenario where methods described herein are used to identify one or more CIs that are equivalent to an input CI, according to an embodiment of the invention.

FIGS. 4A-B depict an example scenario where an input CI is merged with one or more equivalent CIs, and then the one or more CIs that are identified as equivalent to the input CI are merged together, according to an embodiment of the invention.

FIGS. 5A-B depict an example scenario where an input CI is merged with one or more equivalent CIs, and then the one or more CIs that are identified as equivalent to the input CI are compared, but only matching CIs are merged, according to an embodiment of the invention.

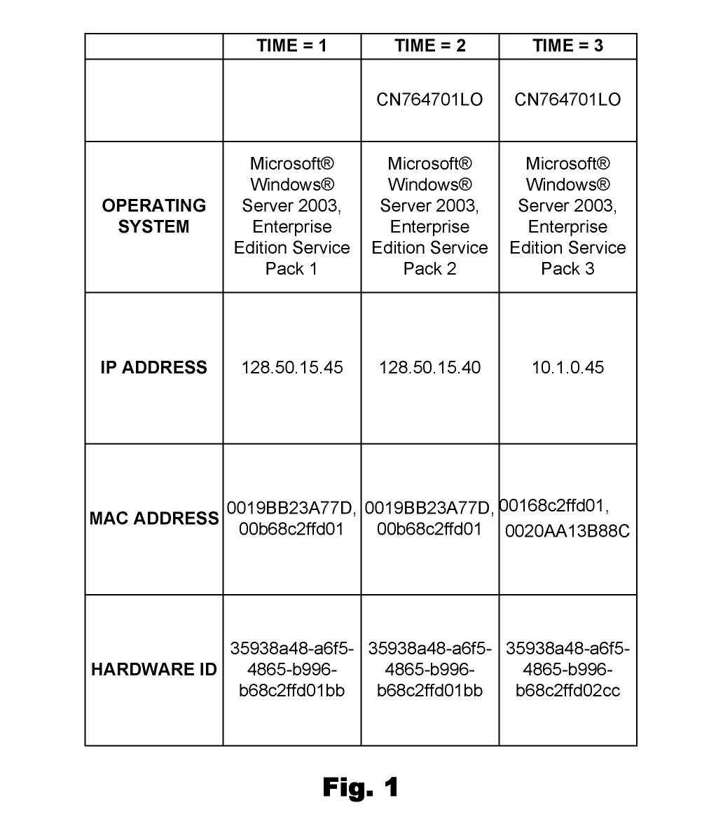

### DETAILED DESCRIPTION

Methods, computer-readable storage media and computer systems are provided for reconciling CIs. A CI may have one or more attributes, each with a value. For example, if a CI is a computer system or host, then that CI may have a number of attributes commonly found on a computer system, such as an operating system, a network address (e.g., IP, MAC), a hardware identifier (e.g., of a motherboard), a host name, and so forth. These attributes may have values such as “Windows NT,” “1.2.3.5,” “sar4f43se43fd3,” and “Sally's computer,” respectively.

A comparison of values of CI attributes may yield various results. Attribute values may “match” when a comparison between them satisfies a particular type of operator, such as equals or contains. In contrast, attribute values may “mismatch” where they conflict, such as by having values that are different or that fail various comparison operators. A third result may occur where a CI involved in a comparison has an attribute value that is empty. An attribute may have an empty value where the attribute value is unpopulated, was never populated, is NULL (e.g., 0x0, NUL, /dev/null or a null pointer), is equal to 0 or “N/A,” and so forth. An empty attribute may not be helpful in determining whether CIs are equivalent, and so additional CI attributes may be compared.

To reconcile CIs, an input CI may first be compared with existing CIs of a CMDB or data stream to identify existing CIs that are equivalent with the input CI. The equivalent CIs may be updated with the input CI's attribute values. If more than one existing CI is identified as an equivalent of the input CI, the CIs identified as equivalent may be compared and merged if equivalent to one another. To “merge” CIs, as the term is used herein, includes combining or consolidating information (e.g., attributes an attribute values) about two or more CIs. For example, two separate CI records in a CMDB may be merged, assuming they are equivalent, by combining information from each into a single CMDB record.

As used herein, the term “input CI” may refer to a newly introduced or target CI that is to be reconciled with one or more existing CIs. The existing CIs to which the input CI may be compared may be CIs described in a CMDB, in a data stream, or that are otherwise stored on a computer system.

Comparing one CI to another CI to determine whether they are equivalent may involve comparing values of attributes of the CIs in various sequences. In some embodiments, the sequence of attribute value comparisons may be organized into groups of criteria referred to herein as Identification Criteria, Match Verification Criteria and Match Resolution Criteria.

An Identification Criterion may be a comparison of a particular attribute of two CIs, and more particularly, a comparison of values of the attribute, that may be meant to identify one CI as a potentially being equivalent to another. Identification Criteria may be applied to existing CIs of a CMDB or data stream to identify one or more existing CIs that are potentially equivalent to an input CI.

Examples of Identification Criteria usable to compare two or more CIs include whether values of hardware identifier attributes are equal, whether a result of a contain operator between values of MAC address attributes returns “true,” whether host name attribute values are equal, and whether a result of a contain operator between IP address attribute values returns “true.”

A Match Verification Criterion may include a comparison of a particular attribute of two CIs, and more particularly, a comparison of values of the attributes. Match Verification Criteria may be applied to potentially equivalent CIs returned from a comparison using Identification Criteria to eliminate CIs having particular attributes with values that do not match those of the input CI. An exemplary Match Verification Criterion includes whether operating system attributes of two CIs have values that are equal.

A Match Resolution Criterion may include a comparison of a particular attribute of two CIs, and more particularly, a comparison of values of the attributes. Match Resolution Criteria may be applied to potentially equivalent CIs that were not eliminated during a comparison using Match Verification Criteria to identify CIs as equivalent to the input CI. Examples of attributes that may be compared using Match Resolution Criteria include hardware identifiers, MAC addresses (e.g., using a contain operator), host names, and IP addresses. Many of these attributes are similar to the attributes that may be used in Identification Criteria. However, a set of attributes that may be included in Identification Criteria and a set of attributes that may be included in Match Resolution Criteria may, in some cases, be entirely disjoint from each other. In other cases, the sets may include some common attributes, one set may be a subset of the other, or the sets may be identical.

Match Resolution Criteria may be selected and sequenced so that more determinative attributes are compared before less determinative attributes. An attribute may be considered more determinative than others where it is more likely that a match between values of the attribute in two CIs indicates equivalence of the CIs. Additionally or alternatively, a user may define the sequence of Match Resolution Criteria based on what attributes the user wishes to be more or less determinative.

Two CIs may be indicated to be equivalent where more determinative attributes match, even where less determinative attributes do not match. For example, two CIs may be identified as equivalent if they have equal hardware identifier attributes, even if the two CIs have different host names or network addresses.

On the other hand, if determinative attributes of two CIs have values that mismatch (i.e., conflict), then the two CIs may be indicated to be not equivalent, even where the CIs share less determinative attributes. For example, if a value of a MAC address attribute of one CI does not match (e.g., is not equal to or does not satisfy a contains operator) a value of a MAC address attribute of another CI, it may not matter that the two CIs have the same host names.

In some embodiments, multiple attributes of Match Resolution Criteria may be equally determinative, and thus may be given the same priority. Even if a comparison of values of a first attribute results in a match, values of a second attribute may be compared anyway. For example, even if a value of a MAC address attribute of one CI matches a value of a MAC address attribute of another CI, values of a host name attribute of the two CIs may be compared to provide further assurance that the CIs truly are equivalent.

An exemplary set of attributes that may be included for comparison in Identification Criteria may include serial number, MAC address (to satisfy a contain operator), host name, and IP address (to satisfy a contain operator). An exemplary attribute that may be included for comparison in Match Verification Criteria with these particular Identification Criteria may be an operating system. An exemplary sequence of attributes that may be included for comparison in Match Resolution Criteria with these particular Identification and Match Verification Criteria may include serial number first, followed by MAC address (again, to satisfy a contain operator), followed by host name.

A CI may have any number of attributes with values that may be compared to values of corresponding attributes of other CIs. Accordingly, ordinal indicators such as “first,” “second,” “third” and “fourth,” when used herein to modify “attributes” of CIs, are meant to differentiate between attributes that are found among CIs generally. For example, a first attribute of CIs in general may be an IP address. Thus, comparing a first attribute of one CI to a first attribute of another CI may include comparing the IP address of the one CI to the IP address of the other CI. Comparing attributes of CIs may include comparing values of the attributes in order to determine whether there is a match. As noted above, a “match” may occur where the attribute values are equal, where they satisfy a contain operator, or where they satisfy some other operator.

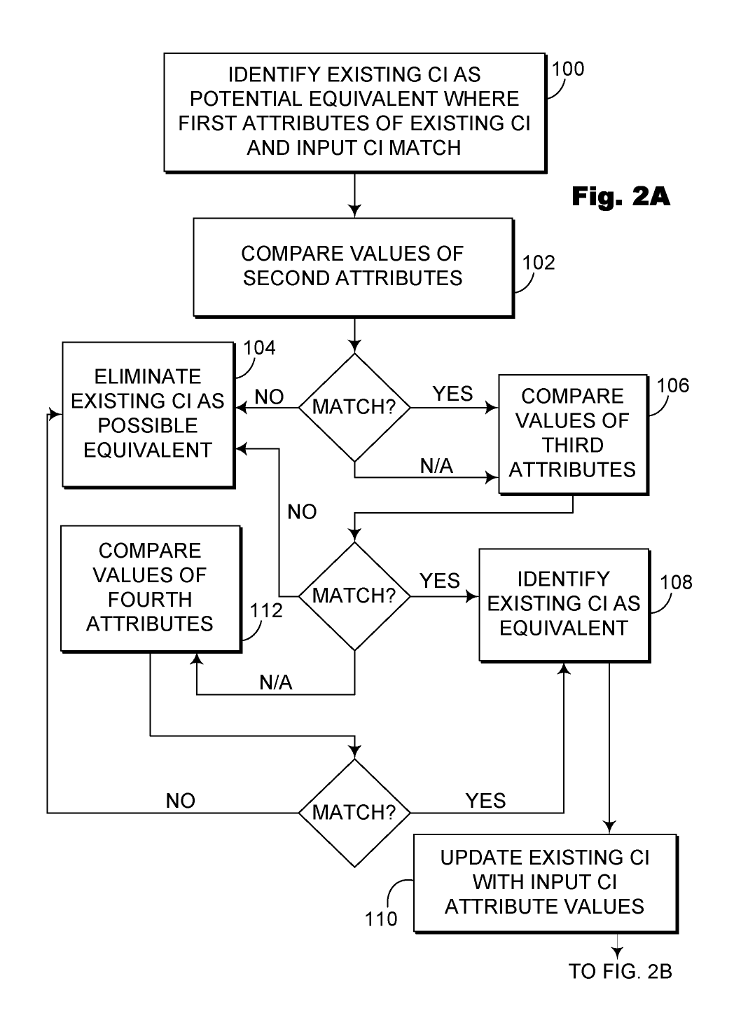

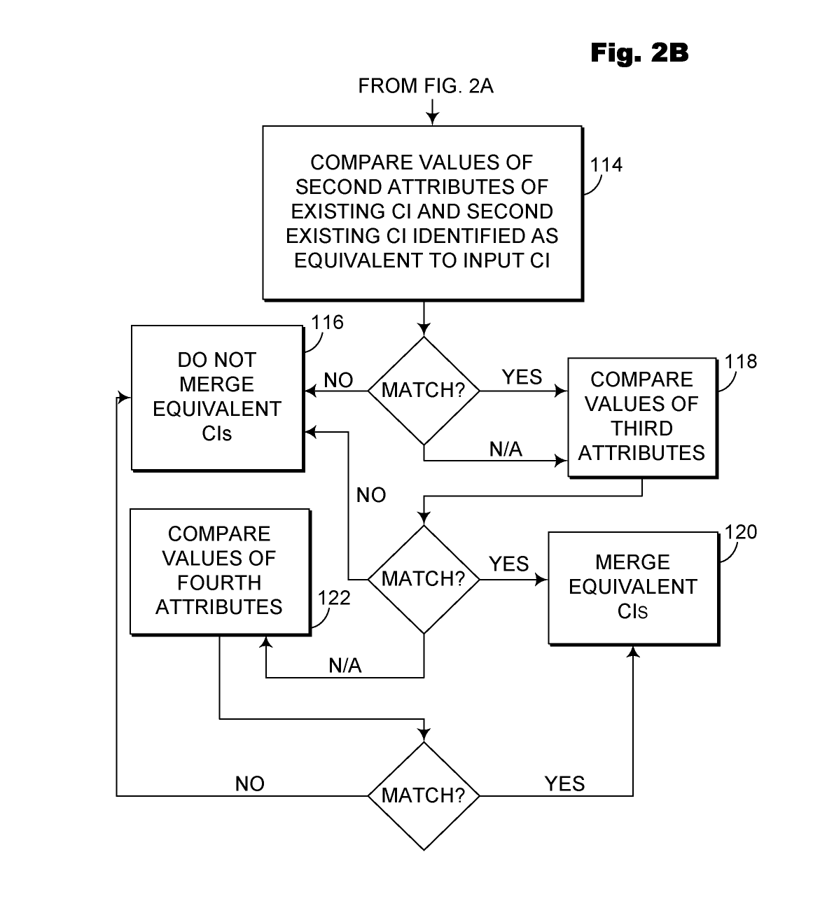

FIG. 2A depicts an exemplary method of reconciling an input CI with one or more existing CIs. In step 100, an existing CI is identified as a potential equivalent to the input CI where a first attribute of the existing CI has a value that matches a value of a first attribute of the input CI. For example, if a value of a hardware identifier attribute of the input CI is “128.23.65.89,” and a value of the hardware identifier attribute of the existing CI is “128.23.65.89,” then a comparison of the two values may produce a match (e.g., because they satisfy an equal operator) and the existing CI may be identified as a potential equivalent.

Although potential CIs are shown being identified in FIG. 2A using a single attribute, it should be understood that a number of attributes may be defined in Identification Criteria. Accordingly, a number of CI attributes may be examined in step 100 to identify potential equivalents, and a CI may be equivalent if a value of any one of those attributes matches that of the input CI.

In step 102, a value of a second attribute of the potentially equivalent, existing CI may be compared with a value of a second attribute of the input CI. In some embodiments, the second attribute may be defined by Match Verification Criteria described above. For example, a value of an operating system attribute of the input CI (e.g., “NT”) and a value of the operating system attribute of the existing CI (e.g., “UNIX”) may be compared.

If the comparison of the second attribute value of the existing CI to the second attribute value of the input CI indicates a mismatch (i.e., neither value is empty and they do not satisfy an operator such as equal or contains), then the existing CI may be eliminated as a potential equivalent in step 104. For example, if a value of a operating system attribute of the input CI is “NT,” and a value of the operating system attribute of the existing CI is “LINUX,” then a comparison of the two values may produce a mismatch and the existing CI would be eliminated as a potential equivalent.

However, if the comparison of the values of the second characteristics of the input CI and the existing CI indicates a match, or if the existing CI or the input CI has an empty value for the second characteristic (indicated as “N/A” in the drawings), then the method may proceed to step 106.

In step 106, a value of a third attribute of the input CI may be compared to a value of a third attribute of the existing CI. In some embodiments, the third attribute may be defined as part of the Match Resolution Criteria described above. For example, if a value of a hardware identifier attribute of the input CI is “hw1,” and a value of the hardware identifier attribute of the existing CI is “hw2,” then a comparison of the two values may produce a mismatch and the existing CI would be eliminated as a potential equivalent.

If the values of the third attributes of the input CI and the existing CI match, then in step 108, the existing CI may be identified as an equivalent to the input CI. Attributes of the existing CI may then be updated with attributes of the input CI in step 110, effectively “merging” the input CI with the existing CI.

However, if the value of the third attribute of either the input CI or existing CI is empty, then the method may proceed to step 112. A value of a fourth attribute of the existing CI may be compared with a value of a fourth attribute of the input CI. As was the case with the third attribute, the fourth attribute may be defined as part of the Match Resolution Criteria described above. Although only four attributes are shown being compared in FIG. 2A, additional attributes may be compared so long as they are defined, in Match Resolution Criteria, for instance. If no comparison defined in Match Resolution Criteria produces a match or a mismatch (e.g., in each comparison, the value of the attribute of at least one of the CIs is empty), then the existing CI may be identified as equivalent to the input CI by default.

Once an existing CI is identified as an equivalent to the input CI, the method may move on to other CIs of the CMDB or data stream to identify more CIs that are equivalent to the input CI. If, after all CIs are tested, only a single CI is identified as an equivalent, then the attribute values of the input CI may be used to update the existing CI that is identified as equivalent, as shown in step 110, and the method may terminate. However, if multiple CIs of the CMDB or data stream are identified as being equivalent to the input CI, then they may be compared with each another and possibly merged together using the steps shown in FIG. 2B. Step 110 of updating the multiple existing CIs with the input CI's attribute values may be performed on each of the multiple equivalent CIs prior to merging, or on the resulting merged CIs after merging is complete.

Comparing and merging multiple CIs that are identified as equivalent to an input CI may be accomplished using similar steps as were used to identify whether an existing CI was equivalent to an input CI. In some embodiments, Match Verification Criteria and Match Resolution Criteria are used again to determine whether two CIs identified as equivalent to the input CI are equivalent to each other, and therefore should be merged.

Referring now to FIG. 2B, in step 114, values of second attributes of the first existing CI (which was identified as an equivalent in step 108 and will now be referred to as the “first equivalent CI”) may be compared to a second CI that was identified as equivalent to the input CI (referred to as the “second equivalent CI”). The second attributes compared in step 114 may be the same second attributes that were compared in step 102, and may once again be defined by Match Verification Criteria described above. If step 114 produces a mismatch, then at step 116, the first and second equivalent CIs are not merged.

However, if step 114 produces a match, or if a value of the second attribute of one of the equivalent CIs is empty, then values of third attributes of the first and second equivalent CIs may be compared at step 118. The third attributes compared in step 118 may be the same third attributes that were compared in step 106, and may once again be defined by Match Resolution Criteria described above. A match between the third characteristics may indicate that the first equivalent CI and the second equivalent CI are equivalent to each other. Accordingly, these CIs may be merged in the CMDB or in the data stream at step 120.

If either of the equivalent CIs have an empty value for the third attribute, then the method may compare values of other attributes (e.g., a fourth attribute in step 122) of the equivalent CIs, to determine whether the CIs should be merged. As was the case with steps 106-110, the Match Resolution Criteria may be sequenced so that more determinative attributes are compared before less determinative attributes.

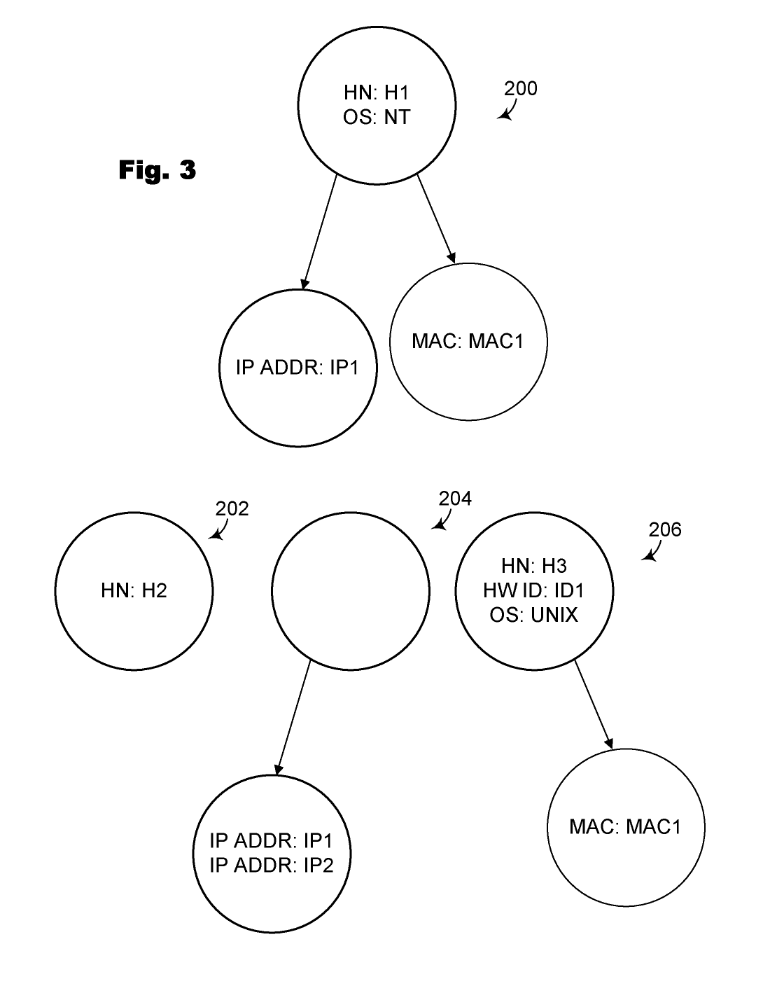

FIG. 3 depicts an example where steps similar to those of FIG. 2A may be performed to determine whether an input CI 200 is equivalent to CIs that exist already in a CMDB or a data stream.

Input CI 200 has a hostname attribute (referred to as “HN” in the drawings) with a value of “H1,” and an operating system attribute (referred to as “OS” in the drawings) with a value of “NT.” Input CI 10 additionally has an IP address attribute (referred to as “IP ADDR” in the drawings) of “IP1, and a network interface with a MAC address (referred to as “MAC” in the drawings) of “MAC1.”

Data about a first existing CI 202 is limited. In fact, the only attribute of the first existing CI 202 that has a value is the hostname attribute, with a value of “H2.” Similarly, data about a second existing CI 204 is limited; the only attribute for which values are known are the IP address attribute, with values of “IP1” and “IP2.” A third existing CI 206 has a hostname attribute with a value of “H3,” a hardware identifier attribute (referred to as “HW ID” in the drawings) with a value of “ID1,” and an operating system attribute with a value of UNIX. Third existing CI 206 also has a network interface with a MAC Address of “MAC1.”

In this example, Identification Criteria include whether hardware identifiers are equal, whether a result of a contain operator between two MAC addresses returns “true,” whether host names are equal, and whether a result of a contain operator between IP addresses returns “true.” Using these criteria, it may be determined that first existing CI 202 is not equivalent to input criteria 200 because first existing CI 202 has a different hostname than input CI 200, and does not have any other attribute values that could be matched to input CI 200.

By contrast, second existing CI 204 may be identified as a potential equivalent to input CI 200. Second existing CI 204 has one IP address attribute with a value of “IP1,” which matches the value of the IP address attribute of input CI 200 (if two values are equal, they each “contain” each other, and therefore satisfy a contain operator).

Third existing CI 206 also may be identified as a potential equivalent to input CI 200. Third existing CI 206 has a MAC address attribute with a value, “MAC1,” that matches (i.e., satisfies contain operator) the value of the MAC address attribute of input CI 200.

Each CI that was identified as a potential equivalent using Identification Criteria (204 and 206) may next be tested using Match Verification Criteria. In this example, there is a single Match Verification Criterion—whether the operating system attribute values match. Second existing CI 204 does not have a value for an operating system attribute, and so it is not eliminated. However, third existing CI 206 has an operating system attribute with a value, “UNIX,” that conflicts with the value of the operating system attribute of input CI 200, “NT.” Accordingly, third existing CI 206 may be eliminated as a potential equivalent CI to input CI 200.

Each CI that was identified as a potential equivalent using Identification Criteria, and that was not eliminated as a potential equivalent using Match Verification Criteria (204), may next be tested using Match Resolution Criteria. In this example, Match Resolution Criteria include whether hardware identifiers are equal, whether a result of a contain operator between two IP addresses returns “true,” and whether host names are equal.

Second existing CI 204 only has two IP address attributes, and one of them has a value that matches the value of the IP address attribute of input CI 200. Accordingly, second existing CI 204 is identified as an equivalent to input CI 200. In some embodiments, particularly where the existing CIs are stored in a CMDB, second existing CI 204 may be updated with the attribute values of input CI 200.

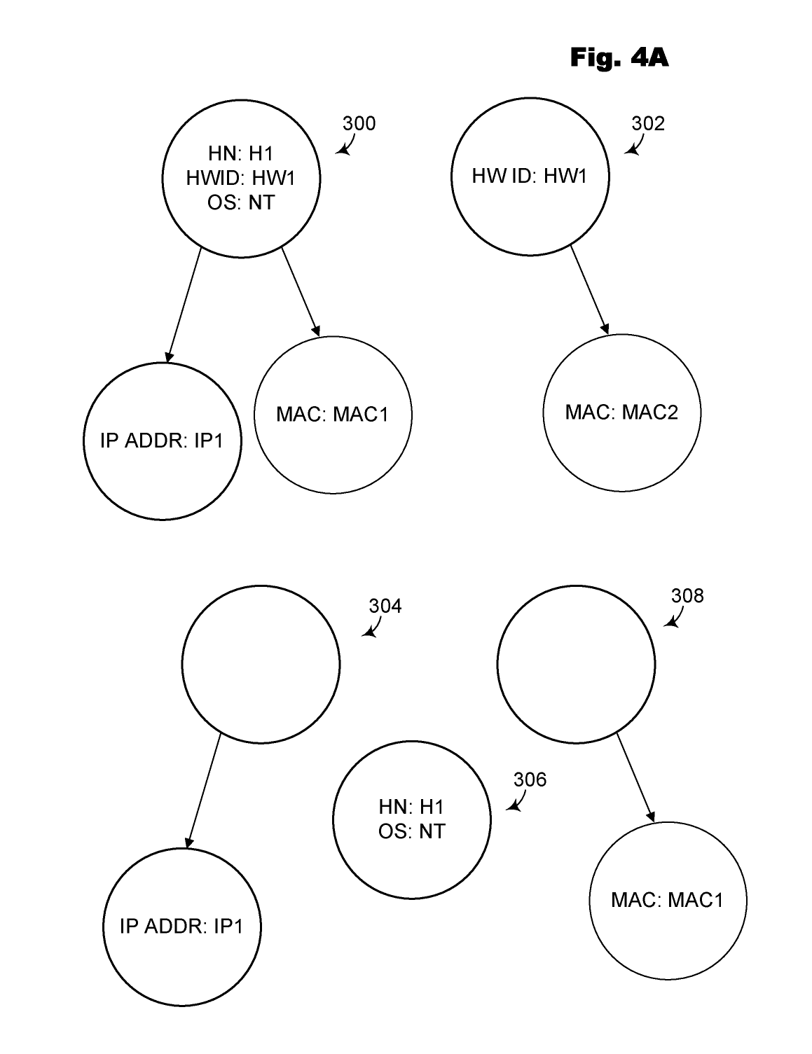

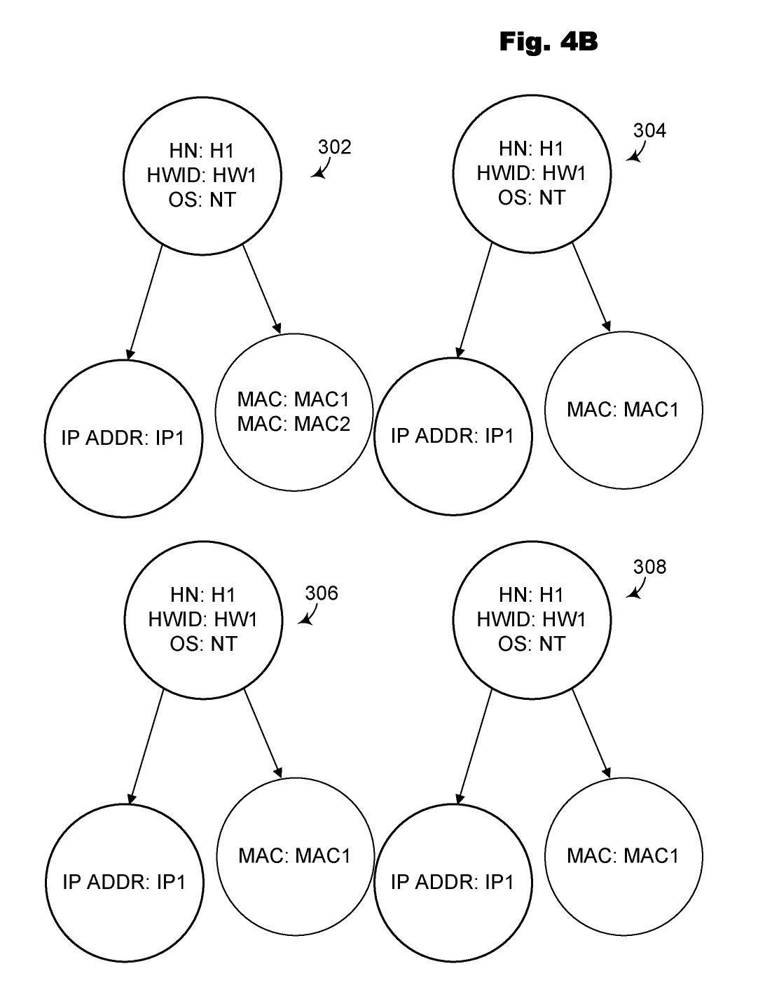

FIG. 4A depicts an example where steps similar to those of FIG. 2A have been performed to determine that four existing CIs are identified as equivalent to an input CI. An input CI 300 has a hostname attribute with a value of “H1,” a hardware identifier attribute with a value of “HW1,” and an operating system attribute with a value of “NT.” Input CI 300 also has an IP address attribute with a value of “IP1,” and a MAC address attribute with a value of “MAC1.”

Three CIs that have been identified as equivalent to input CI 300 (e.g., in step 108) are also shown. A first equivalent CI 302 has a hardware identifier attribute with a value of “HW1,” and a MAC address attribute with a value of “MAC2.” A second equivalent CI 304 has an IP address attribute with a value of “IP1.” A third equivalent CI 306 has a hostname attribute with a value of “H1,” and an operating system attribute with a value of “NT.” A fourth equivalent CI 308 has a MAC address attribute with a value of “MAC1”

As shown in step 110 of FIG. 2A, the existing CIs that are identified as being equivalent to input CI 300 may be updated with values of input CI's attributes, effectively “merging” input CI 300 with each equivalent CI. The results of such a merge are shown in FIG. 4B. First equivalent CI 302 is updated to have a hostname attribute with a value of “H1,” a hardware identifier attribute with a value of “HW1,” an operating system attribute with a value of “NT,” an IP address attribute with a value of “IP1,” and MAC address attributes with values of “MAC1” and “MAC2.” Second equivalent CI 304, third equivalent CI 306 and fourth equivalent CI 308 all have been updated to have a hostname attribute with a value of “H1,” a hardware identifier attribute with a value of “HW1,” an operating system attribute with a value of “NT,” an IP address attribute of “IP1,” and a MAC address attribute with a value of “MAC1.”

The next step is to determine whether the multiple CIs that are identified as equivalent should be merged with each other. This may be accomplished using steps similar to those shown in FIG. 2B, using Match Verification and Match Resolution Criteria. The last three CIs (304, 306, and 308) may be merged regardless of Criteria because they are identical.

Assuming once again that the Match Resolution Criteria include a comparison of MAC address attribute values that is based on a contain operator, first equivalent CI 302 also may be merged with the other three. This is because the MAC address attribute value “MAC1” of the second, third and fourth equivalent CIs (304, 306 and 308) is contained within the first equivalent CI's MAC address attribute value of “MAC1” and “MAC2.” Accordingly, a contain operator is satisfied.

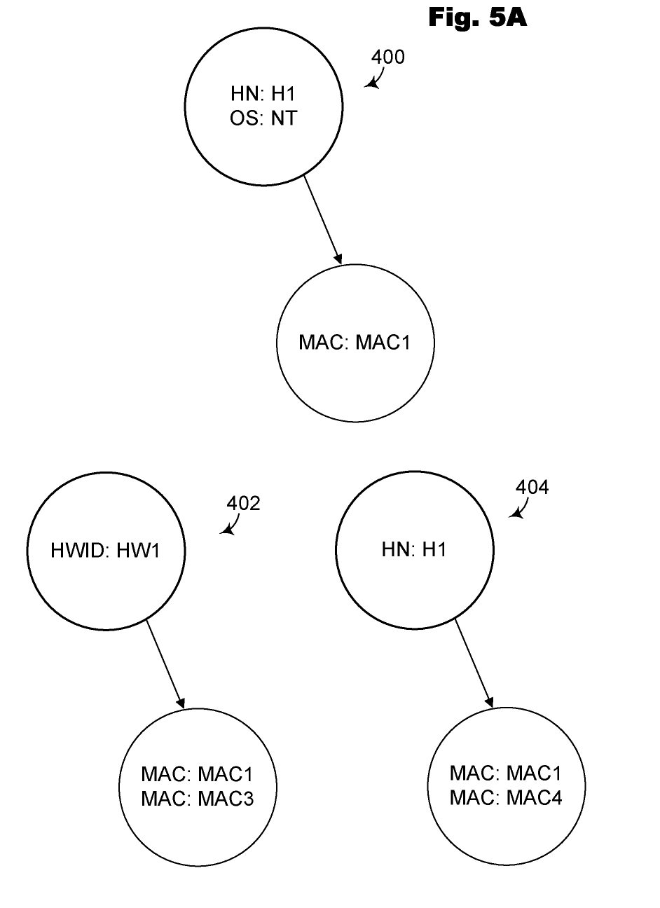

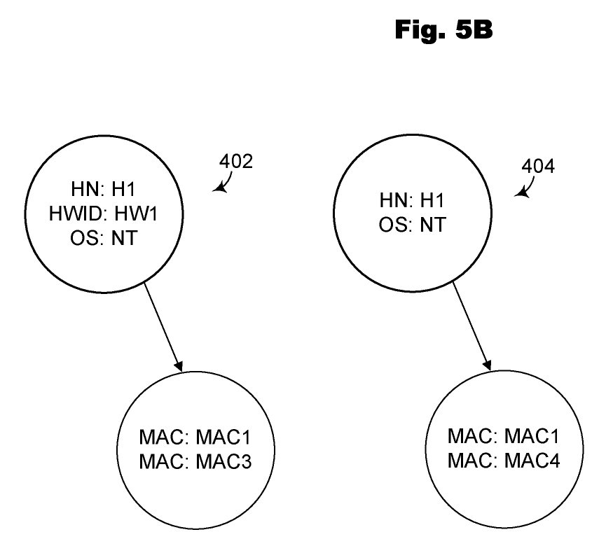

FIG. 5A depicts another example where steps similar to those of FIG. 2A have been performed to determine that two existing CIs are equivalent to an input CI. An input CI 400 has a hostname attribute with a value of “H1,” an operating system attribute with a value of “NT,” and a MAC address attribute with a value of “MAC1.” A first equivalent CI 402 has a hardware identifier attribute of “HW1” and a MAC address attribute having values “MAC1” and “MAC3.” A second equivalent CI 404 has a hostname of “H1” and a MAC address attribute having values “MAC1” and “MAC4.”

Using steps similar to those shown in FIG. 2A, the attribute values of first equivalent CI 402 and second equivalent CI 404 may be updated with attribute values from input CI 400. The results are shown in FIG. 5B. First equivalent CI 402 now has a hostname attribute with a value of “H1,” a hardware identifier attribute of “HW1,” an operating system attribute with a value of “NT,” and a MAC address attribute with values of “MAC1” and “MAC3.” Second equivalent CI 404 now has a hostname attribute with a value of “H1,” an operating system attribute with a value of “NT,” and a MAC address attribute with values of “MAC1” and “MAC4.”

When first equivalent CI 402 and second equivalent CI 404 are compared using Match Verification Criteria (e.g., comparing operating system attribute values), they may not be eliminated as having potential for merger because there may be no conflict between values of attributes that are part of the Match Verification Criteria. However, assuming MAC address is a highly determinative attribute of the Match Resolution Criteria, then first equivalent CI 402 and second equivalent CI 404 may not be identified as equivalent to each other. A comparison of the values of their MAC address attributes does not satisfy a contain operator, and therefore, would indicate a mismatch.

The disclosure set forth above may encompass multiple distinct embodiments with independent utility. The specific embodiments disclosed and illustrated herein are not to be considered in a limiting sense, because numerous variations are possible. The subject matter of this disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether directed to a different embodiment or to the same embodiment, and whether broader, narrower, equal, or different in scope to the original claims, also are regarded as included within the subject matter of the present disclosure.

Where the claims recite “a” or “a first” element or the equivalent thereof, such claims include one or more such elements, neither requiring nor excluding two or more such elements. Further, ordinal indicators, such as first, second or third, for identified elements other than attributes of CIs as described above, are used to distinguish between the elements, and do not indicate a required or limited number of such elements, and do not indicate a particular position or order of such elements unless otherwise specifically stated.

We claim:

1. A method of reconciling an input configuration item (“CI”) with one or more existing CIs, each CI representing an entity on a computer network, comprising:
identifying an existing CI as a potential equivalent to the input CI where a first attribute of the existing CI has a value that matches a value of a first attribute of the input CI; and
eliminating the existing CI as a potential equivalent where a comparison of a value of a second attribute of the existing CI with a value of a second attribute of the input CI indicates a mismatch.

2. The method of claim 1, further comprising comparing a value of a third attribute of the existing CI with a value of a third attribute of the input CI where the comparison of the values of the second attributes indicates a match or one of the existing CI and the input CI has an empty value for the second attribute.

3. The method of claim 2, further comprising eliminating the existing CI as a potential equivalent where the comparison of the values of the third attributes indicates a mismatch.

4. The method of claim 2, further comprising comparing a value of a fourth attribute of the existing CI with a value of a fourth attribute of the input CI where the comparison of the values of the third attributes indicates a match or one of the existing CI and the input CI has an empty value for the third attribute.

5. The method of claim 2, further comprising identifying the existing CI as an equivalent to the input CI where the comparison of the values of the third attributes indicates a match.

6. The method of claim 5, further comprising updating attributes of the existing CI with attributes of the input CI.

7. The method of claim 1, wherein the first attribute is one of a hardware ID and a host name.

8. The method of claim 1, wherein the first attribute is one of a MAC address and an IP address.

9. The method of claim 8, wherein the values of the first attributes match based on a contain operator.

10. The method of claim 1, wherein the second attribute is an operating system.

11. The method of claim 1, wherein the third attribute is one of a hardware ID and a host name.

12. The method of claim 1, wherein the third attribute is one of a MAC address and an IP address.

13. The method of claim 12, wherein the values of the third attributes match based on a contain operator.

14. The method of claim 6, further comprising merging, with the existing CI, a second existing CI that is identified as an equivalent to the input CI where:
one of the existing CIs identified as equivalent to the input CI has a second attribute with a value that either matches the value of the second attribute of the other of the existing CIs, or that is empty; and
the second existing CI has a third attribute with a value that matches the value of the third attribute of the existing CI.

15. A computer-readable storage medium having computer-executable instructions for reconciling an input CI with one or more existing CIs, the instructions causing a processor to perform steps comprising:
identifying an existing CI as a potential equivalent to the input CI where a first attribute of the existing CI has a value that matches a value of a first attribute of the input CI;
eliminating the existing CI as a potential equivalent where a comparison of a value of a second attribute of the existing CI to a value of a second attribute of the input CI indicates a mismatch; and
comparing a value of a third attribute of the existing CI to a value of a third attribute of the input CI where the comparison of the values of the second attributes indicates a match or one of the existing CI and the input CI has an empty value for the second attribute.

16. The computer-readable storage medium of claim 15, further including computer-executable instructions for comparing a value of a fourth attribute of the existing CI with a value of a fourth attribute of the input CI where one of the existing CI and the input CI has an empty value for the third attribute.

17. The computer-readable storage medium of claim 15, further including computer-executable instructions for:
identifying the existing CI as an equivalent to the input CI where the comparison of the values of the third attributes indicates a match; and
updating attributes of the existing CI with attributes of the input CI.

18. The computer-readable storage medium of claim 15, wherein the first attribute is one of a hardware ID, a host name, a MAC address and an IP address.

19. The computer-readable storage medium of claim 17, further including computer-executable instructions for merging, with the existing CI, a second existing CI that is identified as an equivalent to the input CI where:
one of the existing CIs identified as equivalent to the input CI has a second attribute with a value that either matches the value of the second attribute of the other existing CI, or that is empty; and
the second existing CI has a third attribute with a value that matches the value of the third attribute of the existing CI.

20. A computer system for reconciling an input CI with one or more existing CIs, the computer system being configured to:
identify an existing CI as a potential equivalent to the input CI where a first attribute of the existing CI has a value that matches a value of a first attribute of the input CI;
eliminate the existing CI as a potential equivalent where a comparison of a value of a second attribute of the existing CI with a value of a second attribute of the input CI indicates a mismatch;
compare a value of a third attribute of the existing CI with a value of a third attribute of the input CI where the comparison of the values of the second attributes indicates a match or one of the existing CI and the input CI has an empty value for the second attribute;
identify the existing CI as an equivalent to the input CI where the comparison of the values of the third attributes indicates a match or one of the existing CI and the input CI has an empty value for the third attribute;
update attributes of the existing CI with attributes of the input CI; and
merge, with the existing CI, a second existing CI that is identified as an equivalent to the input CI.
